(19) United States
(12) Patent Application Publication
(10) Pub. No.: US 2004/0088719 A1
(43) Pub. Date: May 6, 2004

(54) Intercepting calls to document production functions

(76) Inventors: Charles J. Gazdik, Boise, ID (US); Shell Sterling Simpson, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/283,696

(22) Filed: Oct. 30, 2002

(51) Int. Cl. G06F 9/44

(52) U.S. Cl. 719/330; 719/331

(57) ABSTRACT

Intercepting calls to document production functions. In one embodiment of the application, an import address table for the application is accessed, document production functions being supplied by an operating system are identified within the import address table. For each identified document production function, an address associated with that function in the import address table is replaced with an address to be used to access a proxy document production function. In another embodiment, the application is loaded in debugging mode. Once the import address table for the application has been populated with addresses for functions called by the application, the execution of the application is paused. An address, in the import address table, associated with a document production function to which calls from the application are to be intercepted is replaced with an address to be used to access a proxy document production function. Execution of the application is then resumed.

### CROSS REFERENCE TO RELATED APPLICATION

This is a continuation-in-part of the patent application filed on Oct. 30, 2002 under Attorney Docket No. 100201129-1 and entitled, “Intercepting Function Calls.”

### FIELD OF THE INVENTION

The present invention generally relates to altering the behavior of a computer program, and, more specifically, to intercepting calls directed to an operating system module providing a document production function and redirecting those calls to another module providing a desired document production function.

### BACKGROUND

In today's computing environments, applications rely on operating systems to function. Operating systems provide a software platform on top of which applications can run. Operating systems perform basic tasks, such as recognizing input from a keyboard and mouse, sending output to a display screen, keeping track of files and directories on a hard disk drive, and controlling peripheral devices such as printers. Modern operating systems take a modular approach to supporting various applications. For example, a given operating system may make available a number of functions—those functions residing in a series of programming modules. However, a given application may only need a few of those functions. Consequently, programming for all of the functions provided by the operating system need not be loaded into a computer's memory—only the programming for those functions used by the application.

When an application is executed and loaded into a computer's memory, the operating system identifies and also loads into memory each of the operating system's modules that supply functions needed by the application. Such a module might include programming for presenting an interface enabling a user to select a printer and various options for printing a document. All applications compatible with the operating system can call on that module when a user desires to print. Beneficially, the user need only become familiar with a single interface when printing regardless of the application being used.

Like the example of the print interface, many of an operating system's modules supply functions that require user interaction. Often, however, it is desirable for other programming to provide the necessary interaction needed to utilize a given operating system module. For example, a user may desire that programming operating on a server print a document. Where the server is geographically separated from the user, the user is not able to provide the interaction needed to direct the programming on the server to print the document. The user must instead rely on other programming operating on the server to supply the needed interaction. Unfortunately, programming designed to mimic human interaction is often cumbersome and unreliable.

This problem reveals a need for a method for intercepting a function call to a module that displays a user interface for document production and redirecting the function call to a module that can obtain document production data, normally provided through a user interface, programmatically. However, the same techniques used to achieve this goal can be used for a variety of other purposes.

### SUMMARY

Accordingly, embodiments of the present invention operate to intercept a call directed to an operating system's modules used in the process of document production and to redirect those calls to other modules providing desired document production function or functions. In one embodiment of the application, an import address table for the application is accessed, document production functions being supplied by an operating system are identified within the import address table. For each identified document production function, an address associated with that function in the import address table is replaced with an address to be used to access a proxy document production function. In another embodiment, the application is loaded in debugging mode. Once the import address table for the application has been populated with addresses for functions called by the application, the execution of the application is paused. An address, in the import address table, associated with a document production function to which calls from the application are to be intercepted is replaced with an address to be used to access a proxy document production function. Execution of the application is then resumed.

### DESCRIPTION OF THE DRAWINGS

FIG. 1 is a block diagram illustrating the physical and logical components of a computer system.

FIG. 2 is flow diagram illustrating steps taken to load an application and required modules into operational memory.

FIGS. 3-8 are block diagrams illustrating the contents of the operational memory of FIG. 2 as the steps described in FIG. 2 are executed.

FIG. 9 is a block diagram illustrating a computing environment in which various embodiments of the present invention may be implemented.

FIG. 10 is a block diagram illustrating the logical programming elements of a hooking module according to one embodiment of the present invention.

FIG. 11 is a flow diagram illustrating a method in which function calls are intercepted and redirected according to an embodiment of the present invention.

FIGS. 12-19 are block diagrams illustrating the contents of the operational memory of FIG. 9 as the steps described in FIG. 11 are executed according to an embodiment of the present invention.

### DETAILED DESCRIPTION

### Introduction

Modern operating systems take a modular approach to supporting various applications. For example, a given operating system may make available a number of functions—those functions residing in a series of programming modules. However, a given application may only need a few of those functions. Consequently, programming for all of the functions provided by the operating system need not be loaded into a computer's memory—only the programming for those functions used by the application.

Operating systems such as Microsoft Windows® supply one or more document production modules. These modules provide functions that that enable a user to select a document production device or service such as a printer or fax software and for selecting production options such as the number of copies, two sided printing, and portrait or landscape page layout. The document production modules supplied by operating systems are designed to provide interfaces for document production that respond to human input. The following is a partial list of document production functions supplied by Microsoft Windows®: OpenPrinter( ), GetPrinter( ), SetPrinter( ), GetPrinterData( ), SetPrinterData( ), PrinterProperties( ), StartDocPrinter( ), EndDocPrinter( ), DocumentProperties( ), GetDeviceCaps( ), DeviceCapabilities( ), CreateDC( ), and CreateIC( ).

When an electronic document is sent to a remote server, human interaction is often not an option. Software operating on the server requires a programmatic interface to produce the document. Also, it is often desirable to tailor a document production user interface to the specific needs of a limited group of users. The modules provided by operating systems provide document production user interfaces broadly designed to meet the needs of the consuming public as a whole. It is expected, then, that various embodiments of the present invention will operate to intercept function calls made to an operating system's document production modules. The intercepted function calls are redirected to modules providing functions more suited to a particular user's needs.

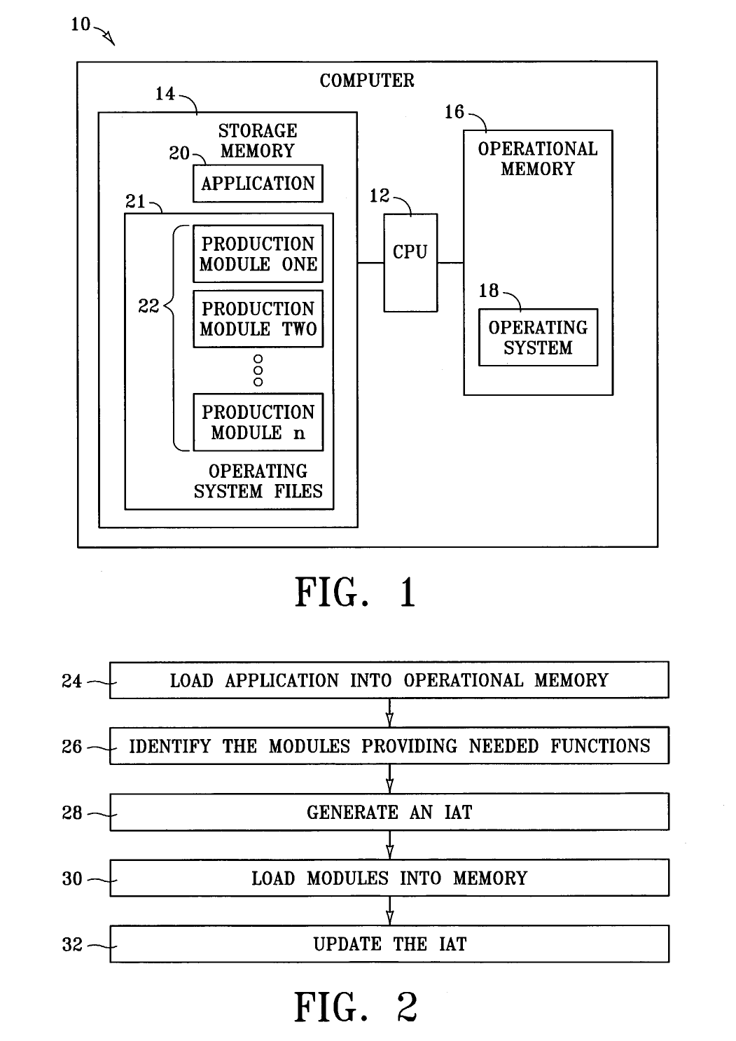

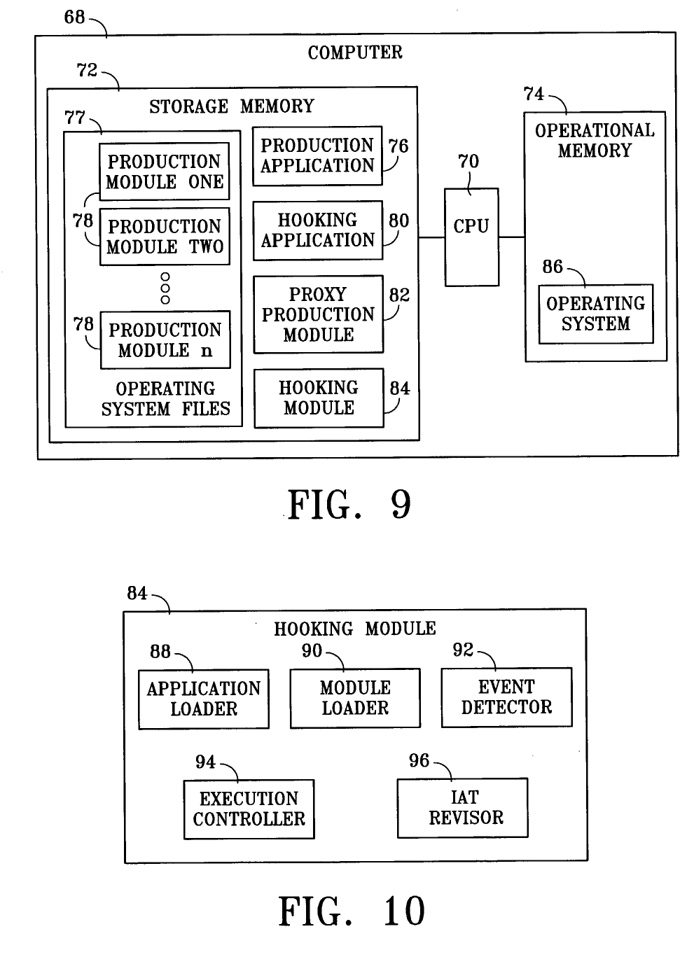

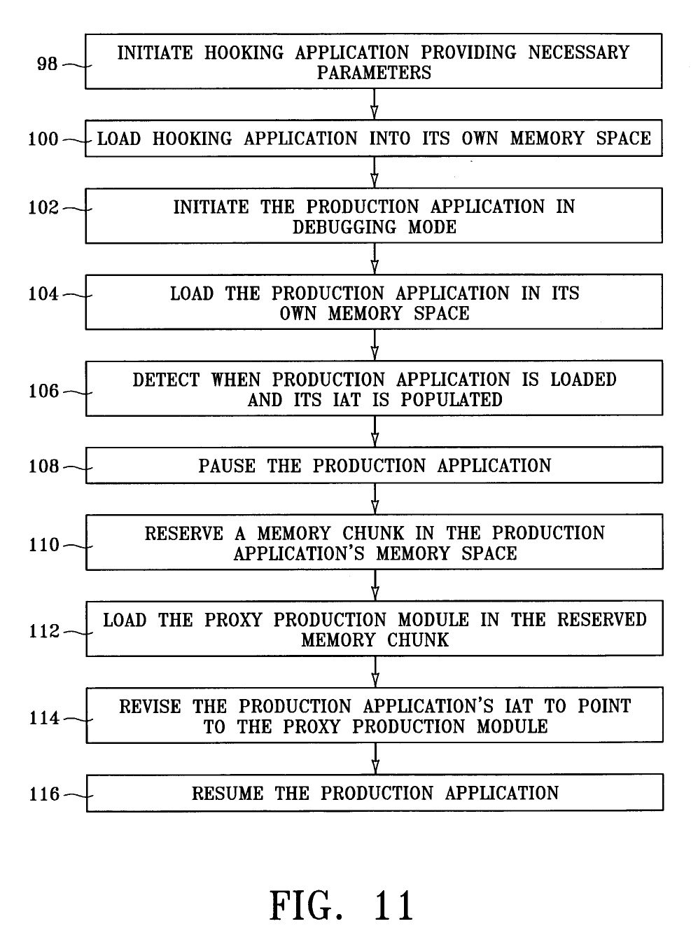

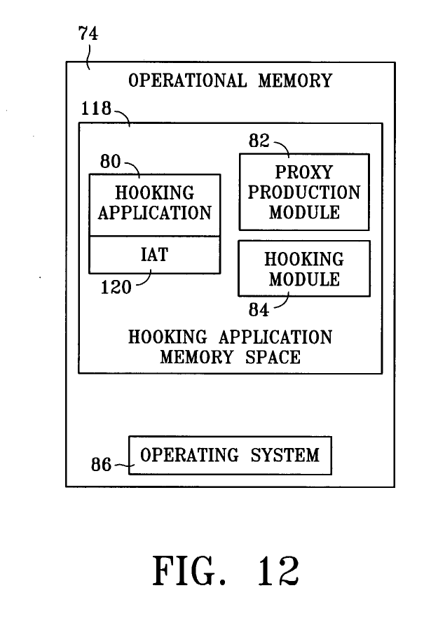

In the description that follows, the steps taken to execute a computer application will be described with reference to FIGS. 1-8. The environment in which various embodiments of the present invention may be implemented is described with reference to FIGS. 9 and 10. Steps taken to practice an embodiment of the present invention are then described with reference to FIG. 11. Finally, an example of one particular implementation of an embodiment of the present invention is described with reference to FIGS. 12-19.

### Application Execution

FIG. 1 is a block diagram illustrating some physical and logical components of a computer 10. Computer 10 includes CPU 12 (Central Processing Unit), storage memory 14, and operational memory 16. CPU 12 represents generally any processor capable of executing computer programs. Storage represents generally any memory designated to store programs and other data when not being used by CPU 12. Typically, storage memory 14 is non-volatile memory able to retain its contents when computer 10 is switched off. Examples include hard disk drives, flash memory, and floppy disks. Operational memory 16 represents generally any memory designated to contain programs and data when in use by CPU 12. Typically, operational memory 16 is volatile memory which loses its contents when computer 12 is switched off. An example of operational memory 16 is RAM (Random Access Memory).

FIG. 1 illustrates computer 10 with only operating system 18 loaded into operational memory 16. Storage memory 14 contains application 20 and operating system file 21 which contains a series of document production modules 22. Application 20 represents generally any computer program application. Production modules 22 represent generally any programming providing document production functions that may or may not be needed by application 20.

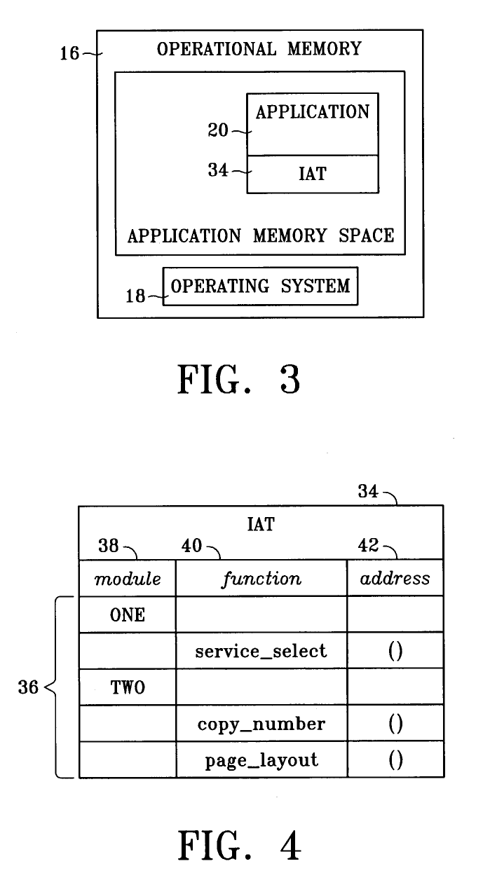

The steps take to execute application 20 using an operating system such as Microsoft Windows® will be described with reference to FIG. 2. FIGS. 3-5 help to illustrate the contents of operational memory as the steps of FIG. 2 are carried out. Upon direction from a user, operating system 18 accesses storage memory 14, locates application 20, and loads application 20 into operational memory 16 (step 24). Application 20 includes an IAT (Import Address Table). The IAT is an array used by application 20 to identify the memory address of the modules identified in step 26. The IAT when functional, associates a unique memory address with a name identifying each function of each identified module. However, as the identified modules have not yet been loaded into operational memory 16, the IAT, at this point, contains the names of the identified modules and the relevant functions provided by each but does not contain addresses. Below, this is illustrated by example with reference to FIGS. 3-5.

Operating system 18 identifies those production modules 22 that contain programming that supply document production functions needed by application 20 (step 26). Operating system 18 loads the production modules 22 identified in step 26 into operational memory 16 (step 30). Now, operating system 18 identifies the memory addresses of the document production functions provided by each of the loaded modules 22 and updates the IAT rendering the IAT functional (step 32). Operating system 18 now executes application 20. When application 20 needs to make a call to a document production function supplied by a loaded production module 22, the address of that function can be identified in the IAT.

FIG. 3 illustrates the contents of operational memory 16 following step 24 Operational memory 16 contains application 20 and IAT 34. IAT 34 includes a series of entries 36—separate entries referencing each module 22 that application 20 needs to operate and each document production function called by application 20 and provided by those modules 22. Each entry 36 includes a module field 38, a function field 40, and an address field 42. For each entry 36 referencing a module 22, the module field 38 contains a name identifying that module 22. For each entry 36 identifying a document production function, the function field 40 contains a name identifying that document production function. In the example of FIG. 3, application 20 needed modules one and two to operate.

The address fields 42 are empty at this point as the modules 22 needed by application 20 to operate have not been loaded. Within module one, application calls a function labeled “service_select.” Within Module two, application 20 calls functions, often referred to as methods, labeled “copy_number” and “page_layout.” These function names are fictional and used only for explanation. Modules one and two may provide other functions, but only those listed in IAT 34 are needed by application 20.

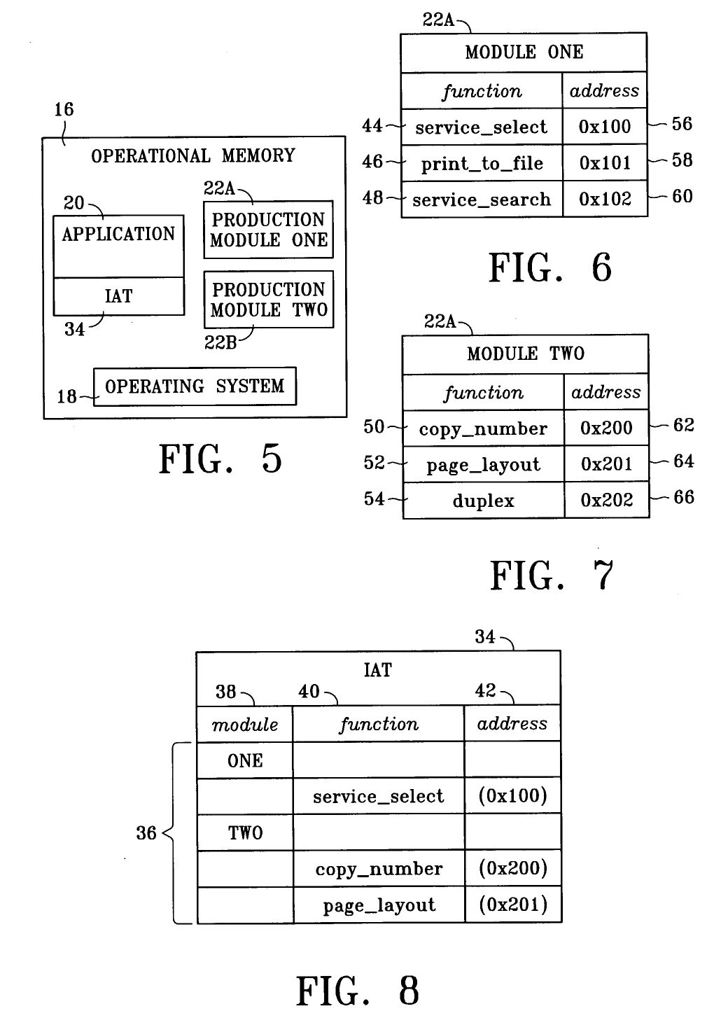

FIG. 5 illustrates the contents of operational memory 16 following step 30 in which operating system 18 loads the modules 22 needed by application 20 into operational memory 16. The needed modules are labeled module one 22A and module two 22B which are illustrated in more detail in FIGS. 6 and 7 respectively. Module one 22A contains programming providing functions labeled service_select 44, print_to_file 46, and service_search 48. Module two 22B contains programming providing functions labeled copy_number 50, page_layout 52, and duplex 54. Operating system 18 has loaded the programming for each function into one of a series of memory addresses 56-66.

FIG. 8 illustrates the contents of IAT 34 following step 32 in which operating system 18 updates IAT 34. IAT 34 now contains addresses for the service_select, copy_number, and page_layout functions. Whenever application 20 makes a call to any one those document production functions, application 20 or operating system 18 can access IAT 34 to identify the address for that function.

### Environment

FIG. 9 is a block diagram illustrating computer 68 which provides an environment in which various embodiments of the present invention may be implemented. Computer 68 includes CPU 70, storage memory 72, and operational memory 74. Storage memory 72 contains document production application 76, operating system files 77 which include document production modules 78, hooking application 80, proxy document production module 82, and hooking module 84. CPU 70 represents generally any processor capable of executing document production and hooking applications 76 and 80. Operational memory 74 includes operating system 98 which represents generally any programming capable of loading applications 76 and 80 as well as modules 80-84 into operational memory 74 allowing applications 78 and 82 to be executed by CPU 70.

Document production application 76 represents generally any programming serving a document production function on computer 68. Examples include word processors, spreadsheet application, web browsers, image editing applications, and other applications capable of requesting the production of a document. Operating system, files 77 represent generally any programming capable of supporting the execution of an application. Typically, a given operating system file is not loaded into operational memory 74 until an application that relies on the programming functions offered by that file is also loaded. As an example of such programming, each document production module 78 represents generally any programming provided by the operating system supplying a document production function or functions used by document production application 68. Hooking application 80 represents generally any programming capable of altering, in a manner described below, the IAT for the document production application 76 after document production application 76 has been loaded into operational memory 74. As CPU 70 executes document production application 76, the alterations caused by hooking application 80 cause calls from document production application 76 to a function or functions provided by one or more document production modules 78 to be redirected to document production functions provided by proxy document production module 82. Proxy document production module 82, then, represents generally any programming providing proxy document production functions to replace document production functions normally provided by one or more document production modules 78. A given proxy production function, for example, may not display a user interface where the document production function it replaces does. Another proxy production function may display a user interface more tailored to a user's needs than the document production function it replaces.

Hooking module 84 represents generally any programming providing functions needed by hooking application 80. While hooking module 84 is illustrated as a single module, the functions it provides may instead be provided by two or more modules. FIG. 10 illustrates the logical programming elements of hooking module 84. These include application loader 88, module loader 90, event detector 92, execution controller 94, and IAT reviser 96. Application loader 88 represents generally any programming capable of loading document production application 76 into its own memory space in operational memory 74 and then initiating document production application 76 in debugging mode.

A memory space is a portion of operational memory 72 reserved for a particular application and any modules it may need to operate. Each application loaded into operational memory 72 is loaded into its own unique memory space. Generally, only the application is capable of reading or modifying the memory in its address space. Reserving a unique memory space for each application helps to prevent the operation of one application from interfering with the operation of another. Typically address spaces are implemented using virtual memory.

In debugging mode, document production application 76 operates normally except hooking application 80 retains control over certain aspects of document production application 76. For example, hooking application 80 can pause and resume execution of document production application 76 upon detection of certain events. Hooking application 80 also retains the ability to load programming into the memory space of document production application 76. Debugging mode is normally used by program development tools to enable the diagnosis of problems in newly developed programs. Generally, operating systems provide the following capabilities to the debugging application: reading the memory of the debugged application; writing the memory of the debugged application; receiving the notification of when the breakpoint instruction is executed by the debugged application; pausing the execution of the application; resuming the execution of the application; and, terminating the execution of the application. Execution of a breakpoint instruction causes program execution to halt and a notification to be sent. Typically, the debugging application will replace certain instructions of the debugged application with breakpoint instructions in order to cause the debugged application to halt execution at particular points during the execution of the debugged application. When the debugged application halts execution, the debugging application can then examine the state of the application to diagnose any problems with the debugged application.

Module loader 90 represents generally any programming capable of loading proxy document production module 82 into the memory space of document production application 76. Event detector 92 represents any programming capable of detecting one or more events in the execution of document production application 76. An example of such an event includes the occurrence of when document production application 76 has been loaded into operation memory 74 and its IAT includes the addresses of the functions provided by document production modules 78 that it needs to operate. Execution controller 94 represents generally any programming operable to pause and resume the execution of document production application 76. IAT reviser 96 represents any programming capable of identifying, in an import address table for document production application 76, document production functions provided by modules supplied by an operating system. For each identified function, IAT reviser 96 is also responsible for replacing an address used to access that document production functions with an address used to access a proxy document production function provided by proxy document production module 82.

### Operation

The steps take to execute applications 76 and 80 will be described with reference to FIG. 11. Initially, hooking application 80 is initiated providing any necessary parameters such as data identifying document production application 76 and proxy document production module 82 (step 98). In response, operating system 86 reserves a memory space in operational memory 74 for hooking application 80 loading hooking application 80, proxy document production module 82, and hooking module 84 into that memory space (step 100). Reserving space includes the notion of creating a virtual memory space.

When executed by CPU 70, hooking application 80 initiates document production application 76 in debugging mode (step 102). Operating system 86, then, reserves a memory space in operational memory 74 for document production application 76 loading document production application 76 into that memory space (step 104). As with the description above made with reference to FIGS. 2-5, operating system 86 generates an IAT for document production application 76 and loads document production modules 78 into the document production application's memory space. Operating system 86 updates the IAT to contain the addresses for those document production functions provided by the loaded document production modules 78 used by document production application 76. Hooking application 80 detects when document production application 76 has been loaded and its IAT has been updated (step 106) and, in turn, pauses the execution of document production application 76 (step 108).

With document production application 76 paused, proxy document production module 82 are loaded into the memory space for document production application 76 (step 110). To do so hooking application 76 reserves a memory chunk within the memory space for document production application 76. Hooking application 76 loads “bootstrap code” into the reserved memory chunk. Bootstrap code represents generally any programming capable of loading document production proxy modules 82 into the memory space of document production application 76 and to make a call to a function or functions used document production application 76. Hooking application 76 modifies the IAT for document production application 76 so that an address for a function called early in the execution of document production 76 is replaced with an address pointing to the bootstrap code. When document production 76 is started, it makes a call the function using the address in the IAT. Because the address has been changed, the call is routed to the bootstrap code. The bootstrap code loads document production proxy modules 82 into the memory space of document production application 76. In order to preserve the expected behavior of document production 76, the bootstrap code then makes a call to the function document production 76 would have called had its IAT not been modified to include the address for the bootstrap code.

Hooking application 80 revises the IAT for document production application 76. In doing so, hooking application 80 identifies addresses pointing to one or more document production functions provided by one or more loaded document production modules 78. Hooking application 80 then replaces the identified addresses with addresses pointing to one or more proxy document production functions provided by proxy document production module 82 which is now loaded in the memory space for document production application 76 (step 114). Hooking application 80 then resumes the execution of document production application 76 (step 116).

Although the flow chart of FIG. 7 shows a specific order of execution, the order of execution may differ from that which is depicted. For example, the order of execution of two or more blocks may be scrambled relative to the order shown. Also, two or more blocks shown in succession in FIG. 7 may be executed concurrently or with partial concurrence. All such variations are within the scope of the present invention.

### EXAMPLE

FIGS. 12-20 provide examples that help to illustrate the contents of operational memory 74 as the steps of FIG. 7 are carried out. FIG. 12 illustrates operational memory 74 following step 100. Prior to loading hooking application 80 in operational memory 74, operating system 86 reserved memory space 118. Following step 100, memory space 118 contains hooking application 80, proxy document production module 82, and IAT 120 for hooking application 80.

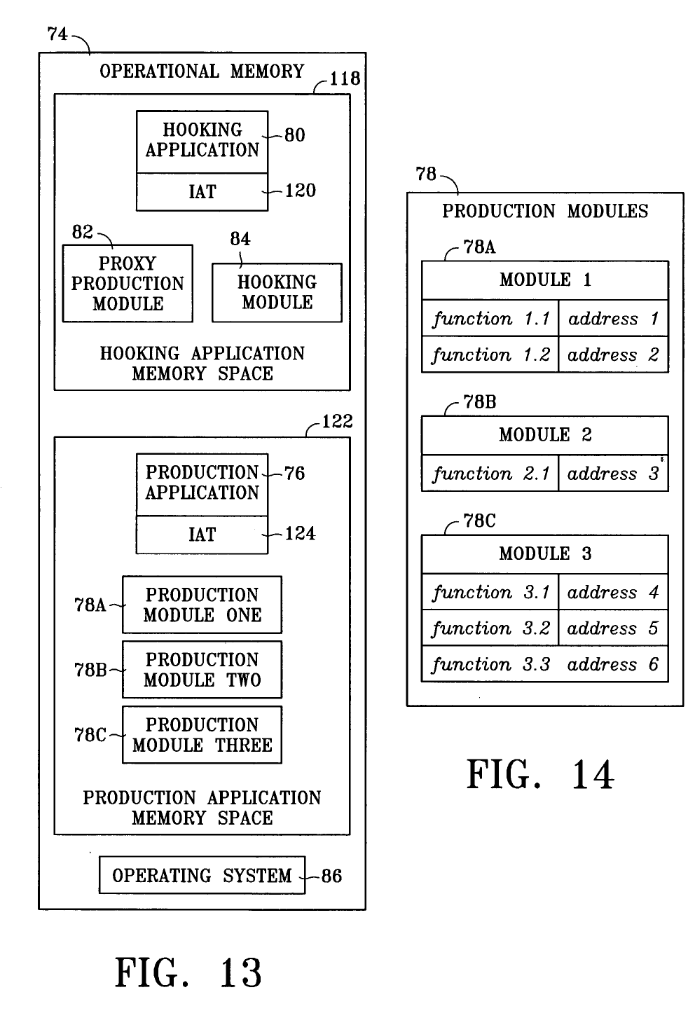

FIG. 13 illustrates operational memory 74 following step 104. Prior to loading document production application 76, operating system 86 reserved memory space 122. In step 104, operating system 86 at the direction of hooking application 80 loaded document production application 76 into memory space 122. Operating system 86 identified and loaded document production modules 78 and created IAT 124 for document production application 76. In the example of FIGS. 13 and 14, document production modules 78 are listed as module one 78A, module two 78B, and module three 78C. Any number of modules may have been loaded in step 102. However, in this example, document production application 76 only uses document production functions provided by modules one, two, and three 78A-78C. Referring to FIG. 14, module one 78A, in this example, provides programming for two document production functions—function 1.1 accessible at address one and function 1.2 accessible at address two. Module two 78B contains programming for a single document production function—function 2.1 accessible at address three. Module three 78C contains programming for three document production functions—function 3.1 accessible at address four, function 3.2 accessible at address five, and function 3.3 at address six.

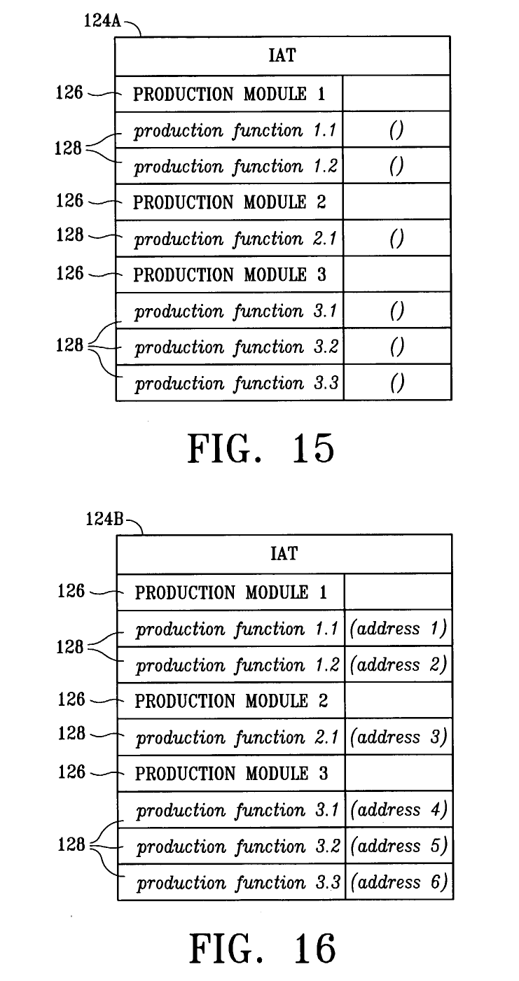

FIG. 15 illustrates IAT 124 before it is updated by operating system 86, while FIG. 16 shows IAT 124 after it has been updated. The before version of IAT 124, referenced as 124A, contains entries 126 for each document production module 78 used by document production application 76 and entries 128 for each document production function provided by document production modules 78 and called by document production application 76. IAT 124A, however does not contain addresses in entries 128. The after version of IAT 124, referenced as 124B, however, does contain addresses for the functions called by document production application 76.

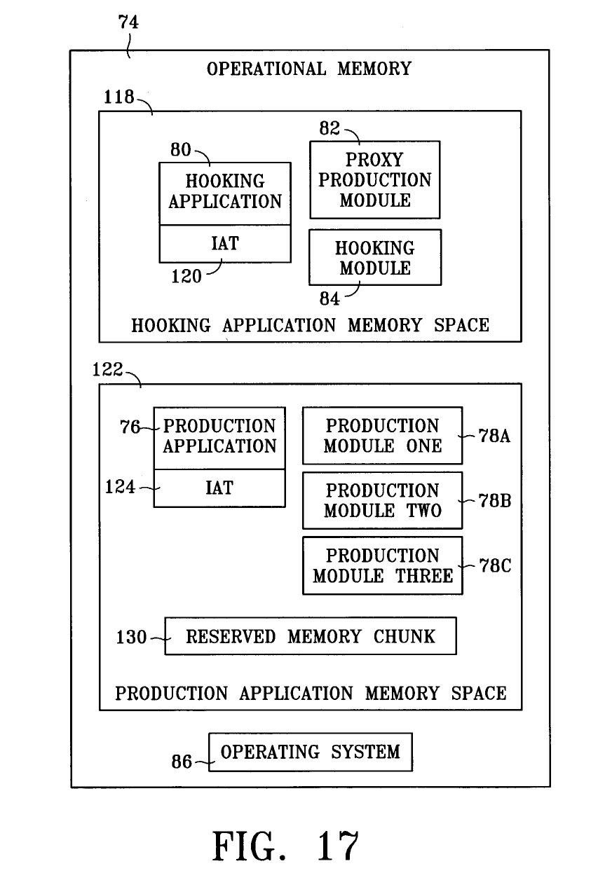

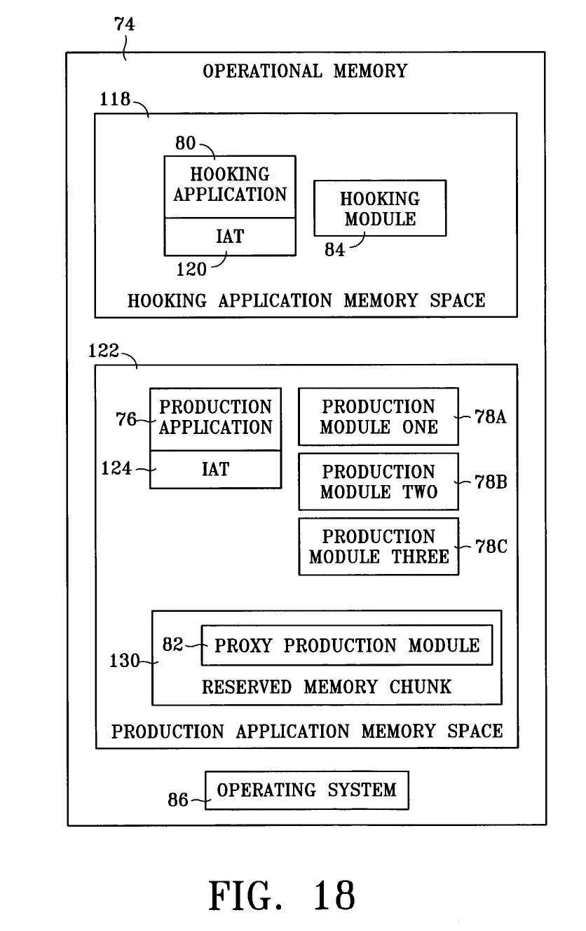

FIG. 17 illustrates operational memory 74 following step 110 in which proxy production module 82 is loaded into production application memory space 122. FIG. 18 illustrates proxy production module 82 in more detail. In this example, proxy document production module provides two proxy document production functions—proxy function 1.2 accessed at address seven and proxy function 3.2 accessed at address eight.

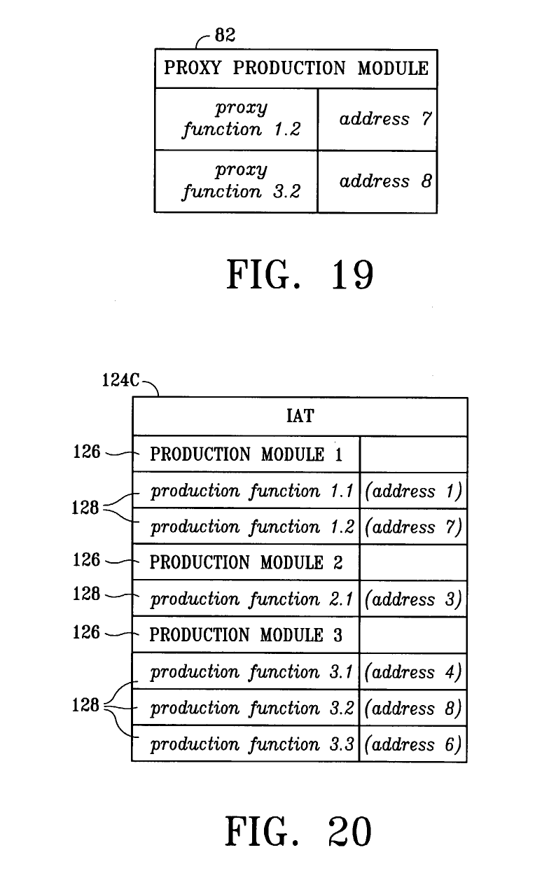

FIG. 19 illustrates IAT 20 after being revised by hooking application 80 in step 114. In the after version if IAT 124, referenced as 124C, the address for function 1.2 has been replaced with address seven—the address for accessing proxy function 1.2. The address for function 3.2 has been replaced with address 8—the address for accessing proxy function 3.2.

Following step 116, when the execution of document production application 76 is resumed and document production application 76 makes calls to document production functions 1.2 and 3.2, those calls are redirected to proxy functions 1.2 and 3.2 accordingly. However, as the programming for document production application 76 has not been altered, the redirection is transparent to document production application 76. It is important to note, that while in the examples illustrated in FIGS. 8-13 two function calls were redirected—functions 1.2 and 3.2 redirected to proxy functions 1.2 and 3.2, any number of function calls can be redirected.

The present invention can be embodied in any computer-readable medium for use by or in connection with an instruction execution system such as a computer/processor based system or other system that can fetch or obtain the logic from the computer-readable medium and execute the instructions contained therein. A “computer-readable medium” can be any medium that can contain, store, or maintain programming for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, a portable magnetic computer diskette such as a floppy diskette or hard drive, a random access memory (RAM), a read-only member (ROM), an erasable programmable read-only memory, or a portable compact disc.

The present invention has been shown and described with reference to the foregoing exemplary embodiments. It is to be understood, however, that other forms, details, and embodiments may be made without departing from the spirit and scope of the invention, which is defined in the following claims.

What is claimed is:

1. A method for intercepting a call from an application to a document production function, comprising:
accessing an import address table for the application;
identifying, in the import address table, document production functions being supplied by an operating system; and
for each identified document production function, replacing, in the import address table, an address associated with that function with an address to be used to access a proxy document production function.

2. A method for intercepting a call from an application to a document production function, comprising:
identifying in the application's import address table an address used to access a document production function provided by an operating system's document production module; and
replacing the identified address in the import address table with an address to be used to access a proxy document production function provided by a proxy document production module.

3. The method of claim 2, further comprising repeating the acts for identifying and replacing for each address in the import address table that is used to access a document production function provided by an operating system's document production module.

4. The method of claim 2, further comprising loading the proxy document production module into operational memory and identifying the address to be used to access the proxy document production function provided by the proxy document production module.

5. The method of claim 2, further comprising:
loading the application in debugging mode;
pausing the execution of the application once the import address table includes addresses for document production functions provided by the operating system's document production module; and
resuming execution of the application after the address for the document production function provided by the document production module has been replaced.

6. The method of claim 5, further comprising:
loading the proxy document production module into the memory space of the application;
identifying the address to be used to access the proxy document production function provided by the loaded proxy document production module; and
wherein replacing comprises replacing the identified address used to access a document production function supplied by the operating system's document production module with the identified address used to an access the proxy document production function.

7. A method for intercepting a call from an application to a document production function, comprising:
loading the application in debugging mode;
pausing the execution of the application once the application's import address table includes addresses for functions provided by an operating system's document production module;
identifying in the application's import address table an address used to access a document production function provided by an operating system's document production module; and
replacing the identified address in the import address table with an address to be used to access a proxy document production function provided by a proxy document production module; and
resuming execution of the application after the address for the function provided by the operating system's document production module has been replaced.

8. The method of claim 7, further comprising:
loading the proxy document production module into the memory space of the application;
identifying the address to be used to access the proxy document production function provided by the loaded proxy document production module; and
wherein replacing comprises replacing the identified address used to access a document production function supplied by the operating system's document production module with the identified address used to an access the proxy document production function.

9. A method for intercepting a call from an application to a document production function, comprising:
loading a proxy document production module into operational memory with the application;
identifying an address to be used to access a proxy document production function provided by the proxy document production module;
identifying in the application's import address table an address used to access a document production function provided by an operating system's document production module; and
replacing, in the import address table, the identified address used to access a document production function supplied by the operating system's document production module with the identified address used to an access the proxy document production function.

10. Computer readable media giving instructions for:
accessing an import address table for an application;
identifying, in the import address table, document production functions being supplied by an operating system; and
for each identified document production function, replacing, in the import address table, an address associated with that function with an address to be used to access a proxy document production function.

11. Computer readable media having instructions for:
identifying in an application's import address table an address used to access a document production function provided by an operating system's document production module; and
replacing the identified address in the import address table with an address to be used to access a proxy document production function provided by a proxy document production module.

12. The media of claim 11, having further instructions for repeating the instructions for identifying and replacing for each address in the import address table that is used to access a document production function provided by an operating system's document production module.

13. The media of claim 11, having further instructions for loading the proxy document production module into operational memory and identifying the address to be used to access the proxy document production function provided by the proxy document production module.

14. The media of claim 11, having further instructions for:
loading the application in debugging mode;
pausing the execution of the application once the import address table includes addresses for functions provided by the document production module; and
resuming execution of the application after the address for the document production function provided by the operating system's document production module has been replaced.

15. The media of claim 14, having further instructions for:
loading the proxy document production module into the memory space of the application;
identifying the address to be used to access the proxy document production function provided by the loaded proxy document production module; and
wherein the instructions for replacing comprise instructions for replacing the identified address used to access a document production function supplied by the operating system's document production module with the identified address used to an access the proxy document production function.

16. Computer readable media having instructions for:
loading an application in debugging mode;
pausing the execution of the application once the application's import address table includes addresses for functions provided by an operating system's document production module;
identifying in the application's import address table an address used to access a document production function provided by an operating system's document production module; and
replacing the identified address in the import address table with an address to be used to access a proxy document production function provided by a proxy document production module; and
resuming execution of the application after the address for the function provided by the operating system's document production module has been replaced.

17. The media of claim 16, having further instructions for:
loading the proxy document production module into the memory space of the application;
identifying the address to be used to access the proxy document production function provided by the loaded proxy document production module; and
wherein the instructions for replacing comprise instructions for replacing the identified address used to access a document production function supplied by the operating system's document production module with the identified address used to an access the proxy document production function.

18. Computer readable media having instructions for:
loading a proxy document production module into operational memory with an application;
identifying an address to be used to access a proxy document production function provided by the proxy document production module;
identifying in the application's import address table an address used to access a document production function provided by an operating system's document production module; and
replacing, in the import address table, the identified address used to access a document production function supplied by the operating system's document production module with the identified address used to an access the proxy document production function.

19. A system for intercepting a call made by an application to a document production function, comprising:
a module loader operable to load a proxy document production module into operational memory with the application; and
a reviser operable to identify an address to be used to access a proxy document production function provided by the proxy document production module, access an import address table for the application, identify in the application's import address table an address used to access a document production function provided by an operating system's document production module, and replace, in the import address table, an address associated with the identified document production function with the identified address to be used to access the proxy document production function provided by the proxy document production module.

20. A system for intercepting call made by an application to a document production function, comprising:
an application loader operable to load an application in debugging mode;
an event detector operable to detect when the application's import address table includes an address for a function provided by an operating system's document production module
an execution controller operable to pause the execution of the application upon detection by the event detector and to later resume execution of the application; and
a reviser operable to accessing the import address table of the application when paused and replace an address in the import address table used to access a function provided by the operating system's document production module with an address to be used to access a proxy document production function provided by a proxy document production module.

21. The system of claim 20, further comprising a module loader operable to load the proxy document production module into memory with the application, and wherein the reviser is further operable to identify an address to be used to access a proxy document production function provided by the proxy document production module once loaded and to and replace an address in the import address table used to access a function provided by the operating system's document production module with the identified address to be used to access the proxy document production function.

22. A system for intercepting a call made by an application to a document production function, comprising:
a means for accessing an import address table for the application;
a means for identifying in the import address table a document production function provided by an operating system and to which calls from the application are to be intercepted; and
a means for replacing, in the import address table, an address associated with the identified document production function with an address to be used to access a proxy document production function.

23. A system for intercepting a call made by an application to a document production function, comprising:
a means for accessing the application's import address table; and
a means for replacing an address in the import address table used to access a document production function provided by an operating system's document production module with an address to be used to access a proxy document production function provided by a proxy document production module.
